(19) United States
(12) Patent Application Publication
(10) Pub. No.: US 2014/0260824 A1
(43) Pub. Date: Sep. 18, 2014

(54) TOOL FOR MULTI-SIDED COMPONENTS

(71) Applicant: Invacare Coporation, Elyria, OH (US)

(72) Inventor: Robert Bekoscke, JR., Medina, OH (US)

(73) Assignee: Invacare Coporation, Elyria, OH (US)

(21) Appl. No.: 13/835,072

(22) Filed: Mar. 15, 2013

(51) Int. Cl. B25B 13/04; B25B 23/00

(52) U.S. Cl. CPC B25B 13/04; B25B 23/00
USPC 81/124.4; 81/121.1

(57) ABSTRACT

A tool having a body that includes at least one aperture is provided. The aperture has a closed perimeter of side walls and a plurality of spaces. The plurality of spaces include a central space and a plurality of auxiliary spaces disposed radially outward from the central space. Each space is configured to receive a multi-sided component therein. The multi-sided component can be a hexagonal nut or bolt head or other polygonal component.

### BACKGROUND

Multi-sided components such as, for example, hexagonal nuts or bolt heads, are used to fasten parts together in many industries. The wide spread use of such components has resulted in their evolvement into different sizes and configurations. For example, an assembly such as a wheelchair, bicycle, bed, lawn mower, chair, table, etc., may utilize hexagonal nuts and/or bolts of several sizes. As a result, the assembler needs to have a tool or tools that can accommodate the differing sizes in order to assemble the article.

### SUMMARY

In one embodiment, a tool having a body that includes at least one aperture is provided. The aperture has a closed perimeter of side walls and a plurality of spaces. The plurality of spaces includes a central space and a plurality of auxiliary spaces disposed radially outward from the central space. Each space is configured to receive a multi-sided component therein. The multi-sided component can be a hexagonal nut or bolt head or other polygonal component.

### BRIEF DESCRIPTION OF THE DRAWINGS

In the accompanying drawings which are incorporated in and constitute a part of the specification, embodiments of the invention are illustrated, which, together with a general description of the invention given above, and the detailed description given below, serve to example the principles of this invention. Further, the embodiments illustrated in the Figures are shown to relative scale, which scale can be modified from that illustrated.

FIG. 1 is a top view of one embodiment of a tool for use with multi-sided components.

FIG. 2 is side view of the tool of FIG. 1.

FIG. 3 is a perspective view of the tool of FIG. 1.

FIG. 4 is a top view of the tool illustrating receipt of a polygonal (e.g., hexagonal) component(s).

FIG. 5 is another top view of the tool illustrating receipt of polygonal (e.g., hexagonal) component(s).

### DESCRIPTION

As described herein, when one or more components are described or shown as being connected, joined, affixed, coupled, attached, or otherwise interconnected, such interconnection may be direct as between the components or may be in direct such as through the use of one or more intermediary components. Also as described herein, reference to a member, component, or portion shall not be limited to a single structural member, component, element, or portion but can include an assembly of components, members, elements, or portions.

Illustrated in FIGS. 1-3 is one embodiment a tool 100 for use with multi-sided components. The tool can be a wrench for use with hexagonal nuts and bolt heads or other fasteners. Other polygonal component shapes are also possible including rectangular, pentagonal, etc. Tool 100 includes a body 102. Body 102 can made from a durable metal or plastic material.

Body 102 includes portions or ends 102 and 104. In the embodiment show, body 102 or body means is substantially planar, but may in other embodiments include different shapes. For example, portions 102 and 104 may be offset from each other so they do not lie in the same plane, but in different planes. In this embodiment, body 102 includes a stepped or offset configuration. Body 102 also includes upper surface 120 and lower surface 200 (see FIG. 2) thereby defining a body thickness.

The central portion of body 102 can be used as a handle for gripping by a user, as may also portions 102 and 104. Tool 102 is intended to be rotated by the user in order to tighten or loosen the multi-sided component (e.g., hexagonal nut or bolt head) it is acting upon. Gripping the tool in this manner provides the orientation necessary for rotating the tool.

In the embodiment shown, portion 104 is configured to receive a multi-sided component such as a hexagonal nut or bolt head or other polygonal shape. Portion 104 includes an aperture having closed perimeter of side walls. The aperture includes a central space 112 or first space means and a plurality of auxiliary spaces 108, 110, and 114 or second space means. While any number of auxiliary or second space means can be provided, the illustrated embodiment shows three.

Auxiliary spaces 108, 110 and 114 are located radially outwardly from central space 112, as indicated by the dashed radial lines emanating from central space 112. In the embodiment shown, auxiliary spaces 108, 110, and 114 are distributed around central space 112 at approximately every 120 degrees. Other angular increments can also be used. Auxiliary spaces 108, 110 and 114 overlap with central space 112. The overlapping nature of this arrangement allows portion 104 to be made compact and still allow for portion 104 to be able to receive a plurality of different sized multi-sided components. This compactness allows tool 100 to be used in very tight areas or areas where there is limited clearance.

In the embodiment shown, each space (e.g., 108, 110, 112, and 114) is configured to receive a multi-sided component of different physical size. For example, central space 112 is configured to receive a component larger than auxiliary spaces 108, 110, and 114. Similarly, auxiliary space 108 is configured to receive a larger component than auxiliary space 110. Similarly, auxiliary space 110 is configured to receive a larger component than auxiliary space 114. This configuration is meant to be illustrative and the relationship between each space, relative to size of the component (e.g., hex nut), can be different from the illustrated embodiment.

Portion 104 also includes a perimeter having a geometry or shape that compliments the compact nature of spaces 108, 110, and 112. In the embodiment shown in FIG. 3, the perimeter or edge of portion 104 includes walls 300-314. Walls 300 and 314 project slightly outwardly from body 102 and walls 302 and 312 project inwardly back toward body 102. This arrangement of outwardly and inwardly projecting surfaces expand the area of body 102 to accommodate spaces 108, 110, and 112 and still allow portion 104 to be compact so tool 100 can be used in areas having limited clearance. The overlapping nature of spaces 108-114 allow portion 104 to have a smaller distance from its edges to the spaces 108-114 than would otherwise be possible absent the overlapping space arrangement and still allow for a plurality of component sizes to be received by portion 104. In other embodiments, portion 104 need not have such a compact design or particular geometry.

In the embodiment shown, portion 106 is also configured to receive a multi-sided component such as a hexagonal nut or bolt head or other polygonal shape. Portion 106 also includes an aperture having closed perimeter of side walls. The aperture includes spaces 116 and 118, which may also be referred to as first and second space means. While any number of spaces can be provided in portion 106, the illustrated embodiment shows two.

Spaces 116 and 118 are disposed in overlapping configuration. This overlapping configuration provides for compactness at portion 106 thereby allowing tool 100 to be used in areas having limited space or clearance. This compact arrangement includes body 102 having walls 316-322. Walls 318 and 320 extend inwardly toward body 102 and form an end portion geometry that complements space 116. As with portion 104, this arrangement allows portion 106 to have a smaller distance from its edges to the spaces 116-118 than would otherwise be possible absent the overlapping space arrangement and still allow for a plurality of component sizes to be received by portion 106. In other embodiments, walls 318 and 320 do not need to form such a complementary arrangement. Spaces 116 and 118 are configured to receive multi-sided components (e.g., hex nut or bolt head) of different size. For example, space 116 is configured to receive a larger component than space 118. In this manner, portions 104 and 106 can accommodate an entire range of sizes of multi-sided components.

Referring now to FIG. 4 and to portion 106, a multi-sided component 400 is shown being received by space 116. In the embodiment illustrated, multi-sided component 400 is in the form of a hexagonal component. Component 400 is received within the space 116, which includes a complimentary geometry. Space 116 includes side walls 402, 404, 406, 408, 410, and 412. As shown, there five corners formed by the six side walls. Also as shown, side walls 402 and 412 are shorter than the other side walls and do not intersect with each other to form a corner. This configuration provides a six-sided geometry for space 116 that works with the hexagonal geometry of component 400 to allow tool 100 to impart a rotational force or motion onto component 400. Alternatively, tool 100 may be used to prevent or resist rotation of component 400.

Still referring to FIG. 4, but now to portion 104, a multi-sided component 414 is shown being received by space 112. In this embodiment, space 112 includes a plurality of side walls including, for example, side walls 416, 418, 420, 422, 424. As shown, these five side walls form two corners. Also as shown, side walls 416 and 418 are shorter than the other side walls and do not intersect with each other. This configuration provides a four-sided geometry for space 112 that works with the hexagonal geometry of component 414 to allow tool 100 to impart a rotational force or motion onto component 414. Alternatively, tool 100 may be used to prevent or resist rotation of component 414.

Furthermore, FIG. 4 illustrates the compact nature of end portion 104 that is provided by the overlapping arrangement of spaces 108, 110, and 112. It can be clearly seen that spaces 108 and 110 are at least partially used by space 112 to receive component 414 thereby reducing the size of end portion 104.

Referring now to FIG. 5 and to portion 106, a multi-sided component 500 is shown being received by space 118. Multi-sided component 500 is also in the form of a hexagonal component. Space 118 includes a plurality of side walls 502, 504, 506, 508, and 510. These five side walls form four corners, as shown. Also, side walls 502 and 504 are shorter than the other side walls and do not intersect each other. Configured as such, a five-sided geometry for space 118 is provided that works with the hexagonal geometry of component 500 to allow tool 100 to impart a rotational force or motion onto component 500. Also, tool 100 can be used to prevent or resist rotation of component 500.

Still referring to FIG. 5, but now to portion 104, a multisided component 514 is shown being received by space 114. Multi-sided component 514 is also in the form of a hexagonal component. Space 114 includes a plurality of side walls 516, 518, 520, 522, and 524. These five side walls form four corners, as shown. Further, side walls 522 and 524 are shorter than the other side walls and do not intersect each other. The five-sided geometry provided by space 114 works with the hexagonal geometry of component 514 to allow tool 100 to impart a rotational force or motion onto component 514. Furthermore, tool 100 may be used to prevent or resist rotation of component 514. Multi-sided components 526 and 528 are also shown received in spaces 108 and 110. Spaces 108 and 110 include a plurality of side walls similar to the configuration of side walls shown for space 118 and function similarly to allow tool 100 to impart rotational force on the multi-sided component or to resist rotational movement of the component. While portion 104 has been illustrated showing three multi-sided components (e.g., 514, 526, 528), it should be understood that portion 104 can be used with a single multi-sided component.

Referring now to FIGS. 4 and 5, the aperture is in portions 104 and 106 are configured to be used with a range of different sizes of multi-sided components ranging from large to small. In this manner, tool 100 can replace a series of individual tools that are limited to a component of one particular size. As such, tool 100 finds particular use in situations where assemblies need to be put together using a range of multi-sided component sizes such as, for example, a range of hexagonal nut or bolt head sizes. Tool 100 would eliminate the need for an assembler to have to switch tools every time a nut or bolt head of different size is encountered during the assembly process. Tool 100 can be also be used in areas with limited clearances due to the compact arrangement of portions 104 and 106. Furthermore, tool 100 can be economically manufactured and, therefore, included in the sale of products that require buyer or end-user assembly or adjustment.

While the present invention has been illustrated by the description of embodiments thereof, and while the embodiments have been described in considerable detail, it is not the intention of the applicant to restrict or in any way limit the scope of the appended claims to such detail. Additional advantages and modifications will readily appear to those skilled in the art. For example, more or less spaces may be provided with the portion apertures to accommodate more or less sizes of components. The number of side walls in each space can be more or less than shown and still allow the tool to impart or provide resistance to rotation movement of the component. Portions of the tool other than the end portions (e.g., 104 and 106) can include apertures for receiving multi-sided components. The apertures and spaces can be configured to receive multi-sided components of polygonal shapes other than hexagonal. Therefore, the invention, in its broader aspects, is not limited to the specific details, the representative apparatus, and illustrative examples shown and described. Accordingly, departures can be made from such details without departing from the spirit or scope of the applicant's general inventive concept.

1. A tool comprising:
a body having an aperture, the aperture comprising a closed perimeter of side walls and a plurality of spaces;
the plurality of spaces comprising a central space and a plurality of auxiliary spaces disposed radially outward from the central space; and
each space configured to receive a multi-sided component therein.

2. The tool of claim 1 wherein the central space is configured to receive a component larger than the component received by the auxiliary spaces.

3. The tool of claim 1 wherein the plurality of auxiliary spaces comprises first, second, and third spaces.

4. The tool of claim 1 wherein the plurality of spaces are each configured to receive components of different sizes.

5. The tool of claim 1 wherein the multi-sided component is a hexagonal component.

6. The tool of claim 1 wherein the central space comprises at least five radially disposed side walls.

7. The tool of claim 1 wherein at least one auxiliary space comprises at least five radially disposed side walls.

8. The tool of claim 1 wherein the plurality of spaces each comprise at least 5 radially disposed side walls.

9. The tool of claim 1 wherein the plurality of spaces at least partially overlap each other.

10. The tool of claim 1 comprising a second aperture having a closed perimeter of side walls and a plurality of spaces configured to receive a multi-sided component.

11. A wrench comprising:
a body having an opening having a closed perimeter and a plurality of spaces therein;
the plurality of spaces comprising large central space and partially overlapping smaller spaces;
the smaller spaces disposed radially outward from the large central space and at a plurality of angles around the central space;
the larger central space and the smaller spaces configured to receive hexagonal components of differing sizes.

12. The wrench of claim 1 wherein the large central space comprises two corners and five side walls.

13. The wrench of claim 1 wherein the smaller spaces comprise four corners.

14. The wrench of claim 1 wherein the smaller spaces comprise four corners and 5 side walls.

15. The wrench of claim 1 wherein the plurality of angles comprise approximately 120 degrees each.

16. The wrench of claim 1 wherein the body comprises a second opening having a plurality of spaces therein configured to receive hexagonal components.

17. A wrench comprising:
a body means;
a space means for receiving a multi-sided component of different sizes; the space means comprising a central space means and a plurality of auxiliary spaces means; and
the plurality of auxiliary spaces means disposed radially outwardly from the central space means in at least three directions and at least partially overlapping the central space means.

18. The wrench of claim 1 wherein the central space means comprises at least five side walls and two corners.

19. The wrench of claim 1 wherein the auxiliary space means comprises at least five side walls and 4 corners.

20. The wrench of claim 1 comprising a second space means for receiving a multi-sided component of different sizes.
